(19) United States
(12) Patent Application Publication
(10) Pub. No.: US 2002/0056110 A1
(43) Pub. Date: May 9, 2002

(54) Method and apparatus for generating revenue for owners and providers of content

(76) Inventor: Francois Rodrigue, Montreal (CA)

Correspondence Address: FRANCOIS RODRIGUE, 4164 AVE. PARC LA FONTAINE, MONTREAL, QC, H2L 3M8, CA

(21) Appl. No.: 09/824,042

(22) Filed: Apr. 3, 2001

Related U.S. Application Data
(60) Provisional application No. 60/195,303, filed on Apr. 10, 2000.

(51) Int. Cl. G06F 17/60

(52) U.S. Cl. 725/60

(57) ABSTRACT

A system (referred to as “service”) and method for generating revenue for owners and providers of content over a network. Through the service, mini-subscriptions are listed and an overview of their content is displayed. End-users have an incentive to make payment to access the content since they can receive money from net revenues generated by the mini-subscription. The mini-subscriptions display a list of homogeneous choices from which a preference can be indicated. Net revenues are redistributed between service provider, end-users who selected the most favored choice, content owners and content providers.

### CROSS REFERENCE TO RELATED APPLICATIONS

Reference is made to and priority claimed from U.S. provisional application Ser. No. 60/195,303, filed Apr. 10, 2000, entitled METHOD AND APPARATUS FOR GENERATING REVENUE FOR OWNERS, CREATORS AND PROVIDERS OF CONTENT.

### BACKGROUND OF INVENTION

The Internet has not yet been used to its full potential mostly because users have not found sufficient motivation to use it as a paying distribution channel. Media content, among other types, has been freely distributed over various web pages and information services. A major problem is that content owners, distributors and content providers do not have an adequate model that allows them to generate revenue from product distribution over the Internet. Variations from conventional brick and mortar approaches have been a straight purchase of the product, with the Internet being the intermediary or distribution medium. Large brand names have tried to sell their content on-line through old e-commerce models such as a flat fee to access the whole of the content. Lesser known content destinations however, have no way of attracting traffic to their site.

End-users are not provided with incentive to use the Internet as a distribution medium to buy products and services. They are rather presented with poor variations of conventional models. In the case of media content, they will instead use existing, free yet illegal, alternatives.

It is thus an object of this invention to provide users with new incentive to use the Internet to pay to purchase a product or pay to access a mini-subscription. With this new incentive to pay for products and services, or pay to access content, content owners and content providers will be able to make money.

### SUMMARY OF INVENTION

The following definitions are used for complete understanding of the present invention:

Category: see sub-category. Grouping of homogeneous content (for example: sports, music, animation, paintings).

Client site: The site, portal that will be using and offering the service to its end-users.

Content: generic term representing any product that can be represented, offered or distributed over the Internet, including audio and video artwork, software, games, literary publications, whether it be in graphic format (such as a picture or a drawing) or a listing.

Content owner: the holder of the intellectual property rights to the content.

Content providers: TV stations, radio stations, websites, portals, newspapers, (example: America Online, Yahoo).

End-User: (also referred to as User) Final participant and user of this system who contributes to generating revenues by paying for content.

Mini-subscription: A list of homogeneous pieces of content that are first grouped into categories and/or sub-categories and later packaged together and made accessible to end-users for a pre-determined amount of time at a pre-determined fee.

Ongoing mini-subscription: mini-subscription for which current date and time fall within the established time parameters for this mini-subscription.

Online Payment Vendor: online service offered by third parties where payment can be made over the Internet.

Path: electronic address of the actual location of a piece of content on content provider's site (example: the location of a music file on content provider server).

Payment Vendor: see Online Payment Vendor.

Portals: larger that a website, they simply offer more choices, options and links to other websites.

Selection: refers to a particular piece of content in a mini-subscription.

Service: term used to designate the object of the present invention.

Service Provider: the entity who is offering the Service.

Sub-Category: see Category. Second level of content grouping. This level is more refined that the Category level.

URL: Uniform Resource Locator.

User: see End-User.

The present invention is particularly suited for websites that provide access to content on the Internet.

Pieces of homogeneous content are grouped together in categories and subcategories, to be packaged into mini-subscriptions, according to the type of content and the objective of the content provider. Upon entering a site or content portal, the user is presented with categories of content. The user selects a category. The user is then presented with various levels of sub-categories of content. The user selects a subcategory. The user is then presented with mini-subscriptions that are offered within this sub-category. The user selects a mini-subscription. An access fee is then paid through an online payment vendor. Once payment is accepted, the user is granted access to the mini-subscription. Individual pieces of content within the mini-subscription can then be accessed for the duration of the mini-subscription. mini-subscription can last for example, two days, a week, a month, as determined in advance by the content provider.

The user can rate, review each piece of content. The user can also e-mail the URL of the content to a friend. At any time during the mini-subscription, the user can vote for his or her favorite piece of content. The user can also place additional votes by paying an additional fee. At the end of the mini-subscription, the piece of content that is the most favored is announced. End-users who voted for the most favored piece of content participate in the net revenues generated by the mini-subscription, along with content owners and content providers.

### BRIEF DESCRIPTION OF DRAWINGS

FIG. 1 describes the process needed for a content provider to install the service.

FIG. 2 describes the process followed by the end consumer (end-user).

FIG. 3 illustrates the distribution of net revenues generated from a typical mini-subscription.

### DETAILED DESCRIPTION

In a preferred embodiment of the invention, a mini-subscription can, for example, last two days and include twenty pieces of content.

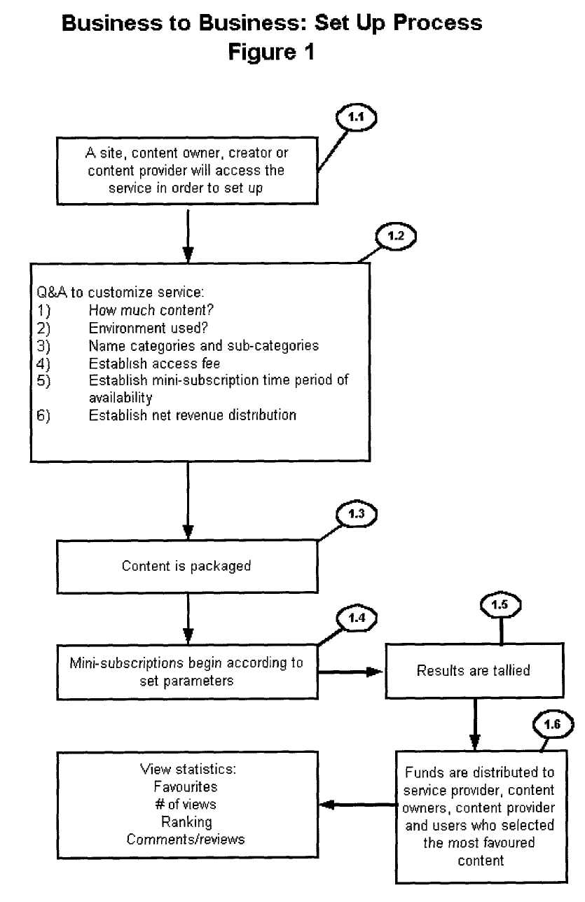

FIG. 1 shows the set-up process needed for content providers. The service is available ^{1.1} on line. The content provider ^{1.2} can customize the service and establishes an account with an online payment vendor to receive payments. A selected number of pieces of content are packaged by the content provider into mini-subscriptions. The content provider can set up as many mini-subscriptions as desired. The mini-subscriptions can then be organized into categories and sub-categories, as necessary. For each mini-subscription, an access fee, start date and duration is established. Once these parameters are set, the path to each piece of content ^{1.3} along with a preview image is entered, if required. Mini-subscription begins ^{1.4} according to set parameters. At the end of the mini-subscription, results are tallied ^{1.5} and net revenues are distributed ^{1.6} to service provider, content owners, content providers (via on-line payment vendors) and end-users (via on-line payment vendors) who selected the most favored piece of content.

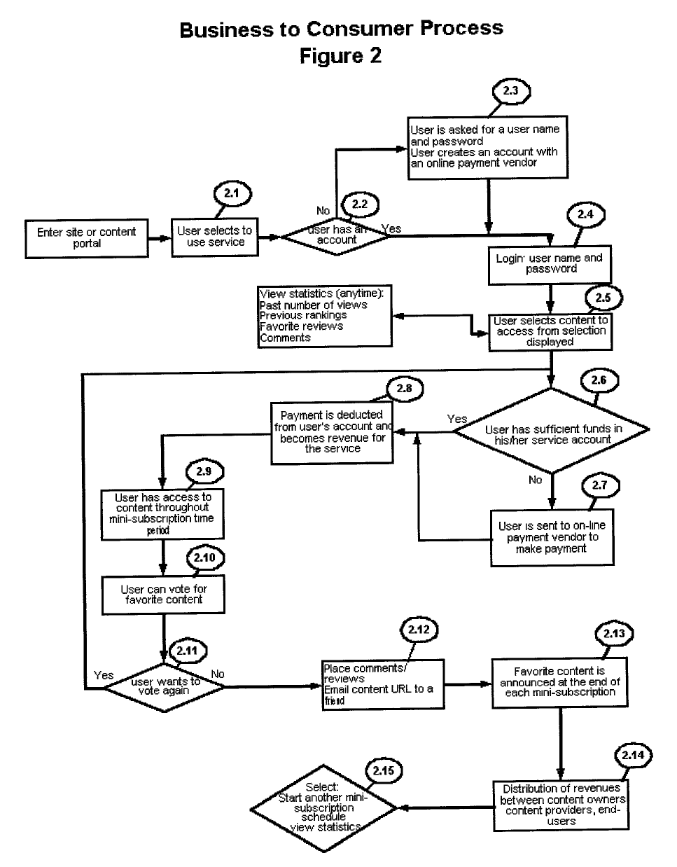

FIG. 2 describes the process followed by the end consumer (end-user). End-users ^{2.1} can access the service through their content provider/portal. If they do not have an account ^{2.2} with the service and are first time users, they must choose a login name and password, establish an account with an on-line payment vendor (a user service account is also created in which account users can deposit money via an on-line payment vendor) and proceed to login. They are asked ^{2.4} to enter a login name and password. They are presented with a list of ongoing ^{2.5} mini-subscriptions (as previously organized into categories, sub-categories by content provider) and a preview image of featured content. If users wish to have access to featured content, the service verifies ^{2.6} if there are sufficient funds in their service account to proceed. If there are insufficient funds ^{2.7}, users are directed to an online payment vendor where payment is made and deposited into users service account. Otherwise, payment is deducted from users service account ^{2.8}. Users are then granted access to mini-subscription content ^{2.9} throughout mini-subscription time frame. At any time during the mini-subscription, users can indicate a choice by voting ^{2.10} for one particular piece of content in the mini-subscription. If users want to vote more than once ^{2.11}, payment process resumes. Users can post comments or send URL ^{2.12} of particular piece of content to friends. At the end of the subscription, the favorite content is announced ^{2.13} and the net revenues ^{2.14} are distributed according to parameters set by the content provider before the launch of the mini-subscription. Users can view statistics or participate ^{2.15} in other mini-subscriptions.

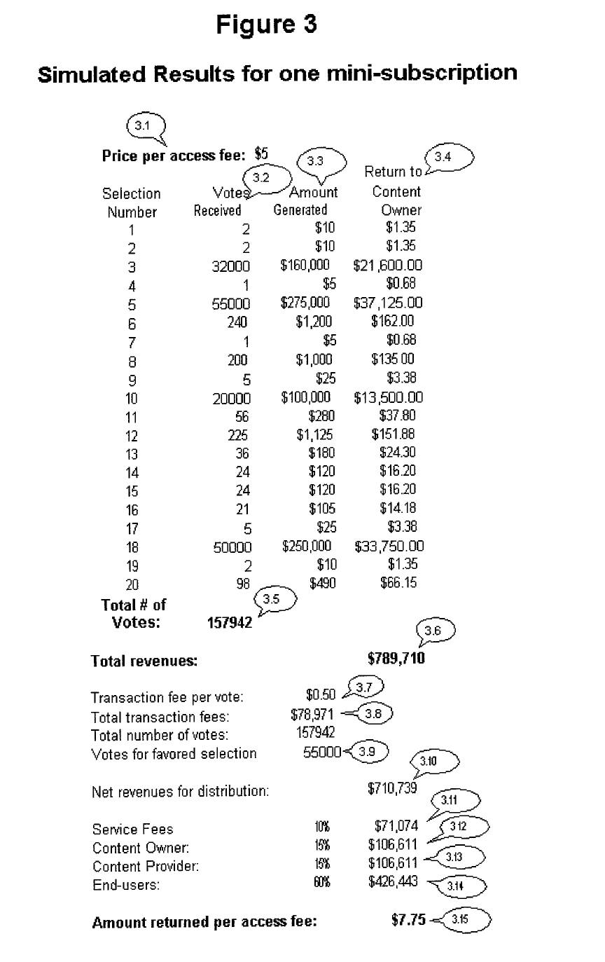

FIG. 3 illustrates an example of the distribution of net revenues generated from a typical mini-subscription. The price to access the mini-subscription ^{3.1} is set by the content provider and is fixed once published and the mini-subscription has begun. In this case, there are 20 selections in this mini-subscription. Once the mini-subscription has started, end-users can indicate their preference by voting for a selection of their choice. The votes received for each piece of content ^{3.2} are tallied. The amount generated ^{3.3} per piece of content represents the number of votes multiplied by the price per access fee. In this case, 15% of net revenues are returned to content owners ^{3.4}, according to the number of votes received by each individual piece of content. In this example, the total number of votes received ^{3.5} is 157,942, which generated the total revenues ^{3.6} of $789,710. The transaction fee ^{3.7} is $0.50 in this case. Next, the service tallies the number of votes received by the most favored piece of content ^{3.9}. The net revenues for distribution ^{3.10} are calculated from the total revenues ^{3.6} less total transaction fees ^{3.8}. The net revenues for distribution are partly used to cover service fees, which is 10% in this case ^{3.11} for an amount of $71,074. The portion going to content owners is, in this case, $106,611 ^{3.12} and represents 15% of net revenues. This amount is distributed proportionally to each content owner according to the number of votes received by their particular piece of content. The content provider also receives 15% of net revenues for an amount of $106,611 ^{3.13}, while end-users who voted for the most favored selection will receive 60% of net revenues, for an amount of $426,443 ^{3.14}, distributed proportionally according to the number of votes placed. The amount returned per access fee is $7.75 ^{3.15}, which is calculated from the amount for distribution to end-users ^{3.14} divided by the number of votes placed on the favorite selection ^{3.9}. In this case, an end-user who paid $5.00 receives $7.75.

What is claimed is:

1] A method and apparatus for packaging homogeneous content into mini-subscriptions for distribution over a telecommunications network, providing incentive for end-users to pay in order to have access to mini-subscription content through the method and apparatus therefore generating revenue, from which the net revenue portion is distributed amongst service provider, content providers, content owners and end-users, the mini-subscription being the model used to offer access or to present content to end-users, content comprising audio and video artwork, representation of artwork, literary publishing, games, software, over which a preference can be expressed by the end-user for the duration of a mini-subscription.

2] A method as claimed in claim 1, wherein mini-subscription parameters such as percentages of distribution of the net revenues between service provider, content providers, content owners and end-users, time period of availability of mini-subscription and access fees to mini-subscriptions are defined before a mini-subscription begins, those parameters being published and accessible to end-users before the beginning and throughout a mini-subscription, and those parameters being fixed once published.

3] A method as claimed in claim 1, wherein end-users pay a fee to access content within a mini-subscription and can indicate their favorite piece of content within a mini-subscription, where those end-users who selected the most favored piece of content receive a share of the net revenues generated from the mini-subscription.

4] A method as claimed in claim 1, wherein users accessing a mini-subscription who wish to place more than one vote have to pay an additional fee, equal to the access fee, for each time they wish to place a vote.

5] A method as claimed in claim 1, wherein a percentage of mini-subscription net revenues is allocated to content owners, this percentage being later distributed to content owners in proportion to the number of votes received by their particular piece of content.
